(19) United States
(12) Patent Application Publication
(10) Pub. No.: US 2003/0135857 A1
(43) Pub. Date: Jul. 17, 2003

(54) Content discovery in a digital broadcast data service

(76) Inventors: Ramesh Pendakur, Hillsboro, OR (US); Alexandre Klementiev, Urbana, IL (US)

Correspondence Address: BLAKELY SOKOLOFF TAYLOR & ZAFMAN, 12400 WILSHIRE BOULEVARD, SEVENTH FLOOR, LOS ANGELES, CA, 90025, US

(21) Appl. No.: 10/044,544

(22) Filed: Jan. 11, 2002

(51) Int. Cl. G06F 3/00; H04N 5/445; G06F 13/00; H04N 7/173

(52) U.S. Cl. 725/61; 725/46; 725/86

(57) ABSTRACT

A method and apparatus are provided for generating and transmitting content on a broadcast network that facilitate content discovery. According to one embodiment of the present invention, a transport protocol is described that uses content discovery information within a broadcast data stream to identify content within the stream. The content discovery information may include a metadata stream and may be transmitted pre-show, in-band or real-time, in-band. A receiver connected with the broadcast network can use the metadata to determine whether the content may be of interest to a particular consumer or user. The receiver may also selectively filter, cache, or personalize the content for the particular consumer.

### FIELD OF THE INVENTION

The invention relates generally to the field of digital broadcasts. More particularly, the invention relates to a protocol for scheduling broadcast content in fixed-bandwidth timeslots.

### BACKGROUND OF THE INVENTION

There are various well-known systems for broadcasting digital information such as digital television content. For example, cable and satellite television broadcast systems presently utilize digital broadcasts to transmit television content to their subscribers. Additionally, over-the-air digital broadcasts of television content are now becoming more common and will continue to replace analog broadcasts.

These digital broadcasts generally provide very large bandwidth. Over-the-air American Television Standards Committee (ATSC) standard digital broadcasts are capable of 19.2 Mbits per second. Cable broadcasts are capable of 30-38 Mbits per channel. Satellite broadcasts operate at speeds of 30 Mbits/transponder. Given the possible speed of these broadcasts, it is not always necessary to send broadcast content to be consumed in real-time. The content could be sent at a high rate and cached for later consumption. However, it would not be efficient or practical to cache all content that is broadcast since consumers are likely to be interested in only particular types of content. Therefore, a caching system should be provided with some information that provides a way of identifying only that content which would be of interest to the consumers.

Currently, broadcasters may include program information service information, or directory information regarding the content being broadcast. Typically, this information may include the time, title, and perhaps a brief description of the content. This information is normally broadcast out-of-band on a predetermined channel within the broadcast spectrum but separate from the channels carrying content. This information, while helpful to a human consumer, is not detailed enough for effective use by a receiver or caching device automatically filter content based on the interests of a particular consumer. More detailed information allows a receiver to perform automatic filtering and caching of content based on a user's preferences.

### BRIEF DESCRIPTION OF THE DRAWINGS

The appended claims set forth the features of the invention with particularity. The invention, together with its advantages, may be best understood from the following detailed description taken in conjunction with the accompanying drawings of which:

FIG. 1A is a diagram illustrating an example of a typical local broadcast system upon which embodiments of the present invention may be implemented;

FIG. 1B is a diagram illustrating an example of a typical satellite broadcast system upon which embodiments of the present invention may be implemented;

FIG. 1C is a diagram illustrating an example of a national broadcast system upon which embodiments of the present invention may be implemented;

FIG. 1D is a diagram illustrating an example of a typical cable broadcast system upon which embodiments of the present invention may be implemented;

FIG. 2 is a block diagram illustrating a high-level, conceptual view of a network for distributing and consuming content according to one embodiment of the present invention;

FIG. 3 is a block diagram illustrating a content provider system according to one embodiment of the present invention;

FIG. 4 is a block diagram illustrating a package generation process according to one embodiment of the present invention;

FIG. 5 is a flowchart illustrating a package generation process according to one embodiment of the present invention;

FIG. 6 is a block diagram illustrating a playlist composition process according to one embodiment of the present invention;

FIG. 7 is a flowchart illustrating a playlist composition process according to one embodiment of the present invention;

FIG. 8 is block diagram illustrating a head-end system according to one embodiment of the present invention;

FIG. 9 is block diagram illustrating a transmission composition process according to one embodiment of the present invention;

FIG. 10 is a flowchart illustrating a transmission composition process according to one embodiment of the present invention;

FIG. 11 is a block diagram illustrating a transmission execution process according to one embodiment of the present invention;

FIG. 12 is a flowchart illustrating a transmission execution process according to one embodiment of the present invention;

FIG. 13 is a block diagram illustrating a transmission format according to one embodiment of the present invention;

FIG. 14 is a block diagram illustrating a transmission format according to an alternative embodiment of the present invention;

FIG. 15 is a block diagram illustrating a transmission format according to an alternative embodiment of the present invention;

FIG. 16 is a block diagram illustrating a receiver system according to one embodiment of the present invention;

FIG. 17 is a flowchart illustrating a package reception process according to one embodiment of the present invention.

### DETAILED DESCRIPTION OF THE INVENTION

A method and apparatus are described for generating and transmitting content on a digital broadcast network. According to one embodiment of the present invention, a transport protocol uses embedded metadata within a broadcast data stream to identify content within the stream. A receiver connected with the broadcast network can use the metadata to determine whether the content may be of interest to a particular consumer or user. In this manner, discovery and availability of content is facilitated.

In the following description, for the purposes of explanation, numerous specific details are set forth in order to provide a thorough understanding of the present invention. It will be apparent, however, to one skilled in the art that the present invention may be practiced without some of these specific details. In other instances, well-known structures and devices are shown in block diagram form.

The present invention includes various methods, which will be described below. The methods of the present invention may be performed by hardware components or may be embodied in machine-executable instructions, which may be used to cause a general-purpose or special-purpose processor or logic circuits programmed with the instructions to perform the methods. Alternatively, the methods may be performed by a combination of hardware and software.

The present invention may be provided as a computer program product which may include a machine-readable medium having stored thereon instructions which may be used to program a computer (or other electronic devices) to perform a process according to the present invention. The machine-readable medium may include, but is not limited to, floppy diskettes, optical disks, CD-ROMs, and magneto-optical disks, ROMs, RAMs, EPROMs, EEPROMs, magnetic or optical cards, flash memory, or other type of media/machine-readable medium suitable for storing electronic instructions. Moreover, the present invention may also be downloaded as a computer program product, wherein the program may be transferred from a remote computer to a requesting computer by way of data signals embodied in a carrier wave or other propagation medium via a communication link (e.g., a modem or network connection).

Importantly, while embodiments of the present invention will be described with reference to the broadcast of television type content, the method and apparatus described herein are equally applicable to other types of content that can be represented in digital form. For example, the techniques described herein are thought to be useful in connection with broadcasting of music, multimedia presentations, text, video, and other forms of digital data.

As mentioned above, there are various well-known systems for broadcasting digital information such as television content. For example, cable and satellite television broadcast systems presently utilize digital broadcasts to transmit television content to their subscribers. Additionally, over-the-air digital broadcasts of television content are now becoming more common and will continue to replace analog broadcasts. Various embodiments of the present invention, as will be described in detail below, are equally applicable to any of these broadcast systems.

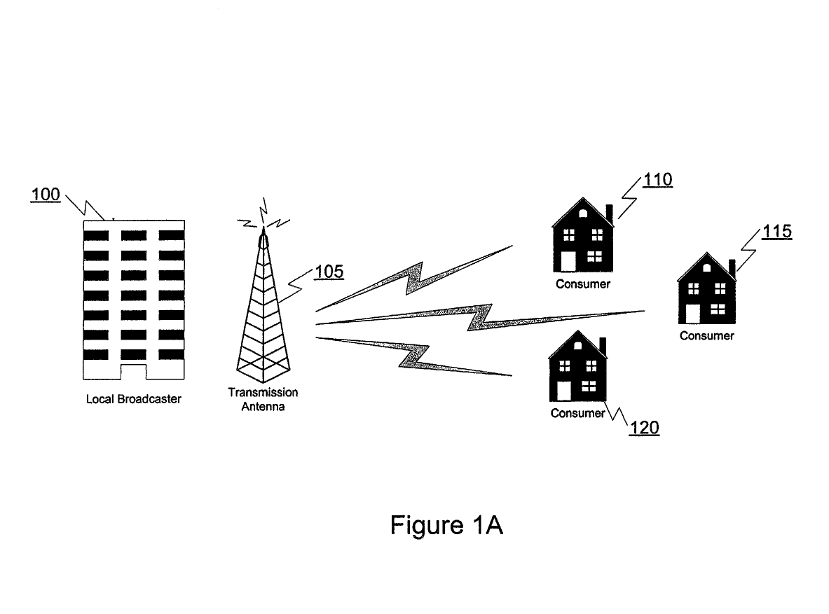

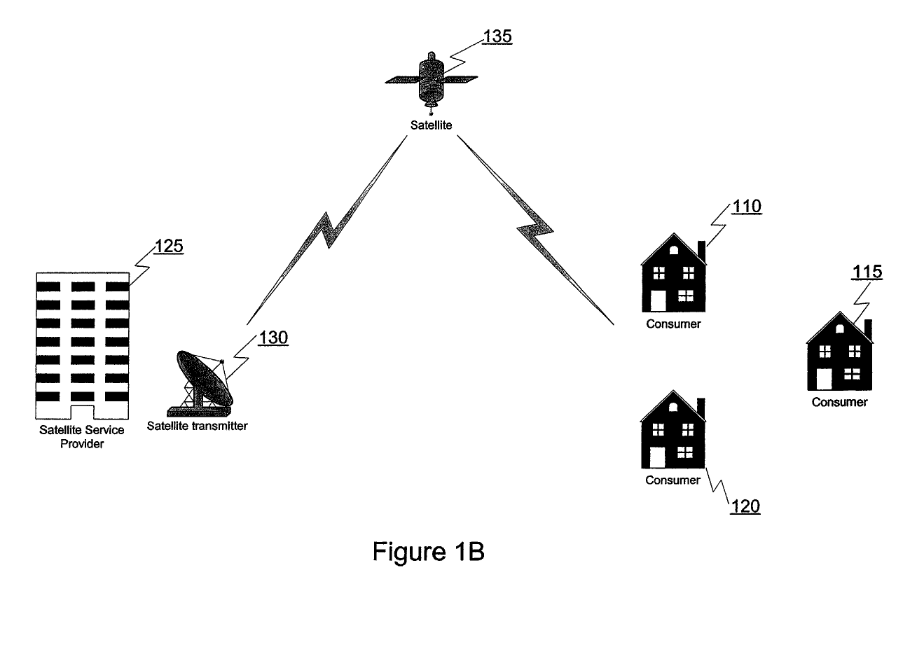

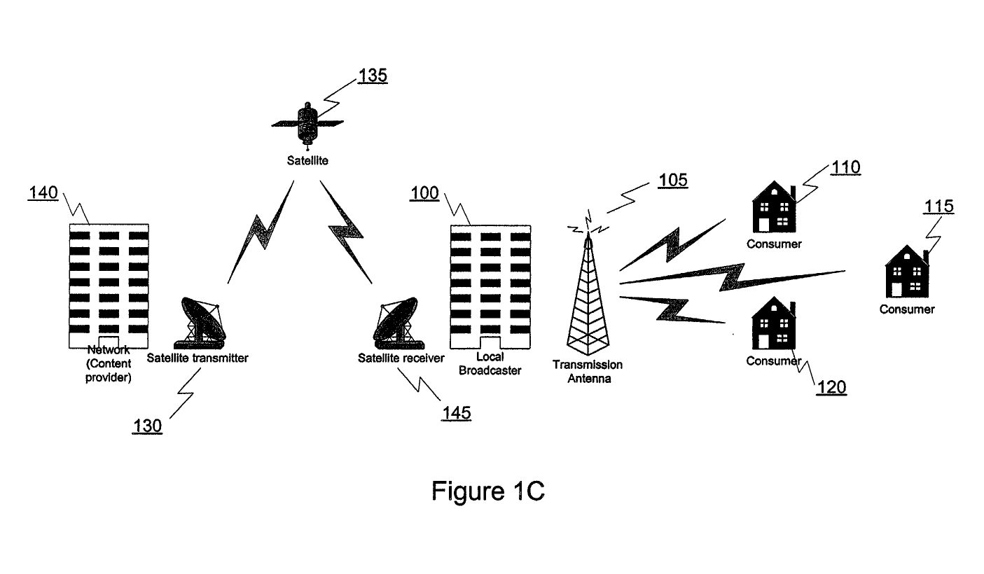

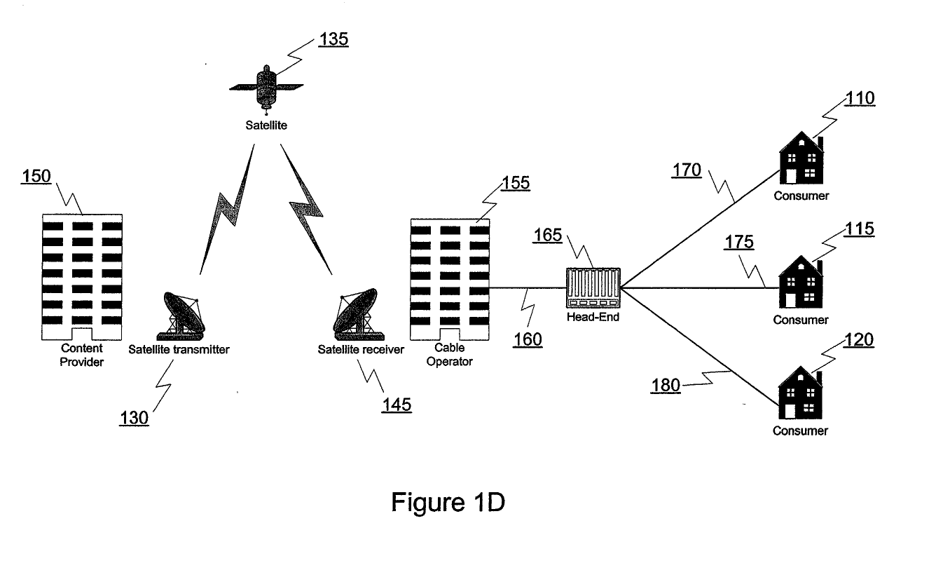

FIG. 1A is a diagram illustrating an example of a typical local broadcast system upon which embodiments of the present invention may be implemented. Here, a local broadcaster 100 is providing content to a group of consumers 110, 115, and 120. The local broadcaster 100, after generating content to be broadcast, modulates a carrier frequency with the content for transmission from a transmission antenna 105 to the consumers 110, 115, 120. The consumers 110, 115, and 120 then receive, demodulate, and consume the content normally in real-time as the broadcast is occurring.

FIG. 1B is a diagram illustrating an example of a typical satellite broadcast system upon which embodiments of the present invention may be implemented. Here, similar to the local broadcaster described above, the satellite service provider 125 generates content and uses it to modulate a carrier frequency for transmission from a satellite transmitter 130 to a satellite 135. The satellite 135 then retransmits the signal to a group of consumers 110, 115, 120 with the proper equipment for receiving and decoding the transmission. The consumers 110, 115, and 120 then receive, demodulate, and consume the content normally in real-time as the broadcast is occurring.

FIG. 1C is a diagram illustrating an example of a national broadcast system upon which embodiments of the present invention may be implemented. This basic example illustrates a system that may be used by one of the national networks. Here, the network 140 is the content provider. The network 140 generates content and uses it to modulate a carrier frequency for transmission from a satellite transmitter 130 to a satellite 135. The satellite 135 then retransmits the signal to a satellite receiver 145 at the local broadcaster 100. The local broadcaster then retransmits the content from a transmission antenna to a group of consumers 10, 115, and 120 who then receive, demodulate and consume the content. Alternatively, the link between the network 140 and the local broadcaster 100 via the satellite transmitter 130, the satellite 135, and the satellite receiver 145 may be replaced by a direct, dedicated connection or a network connection such as an Asynchronous Transfer Mode (ATM) backbone or the Internet.

FIG. 1D is a diagram illustrating an example of a typical cable broadcast system upon which embodiments of the present invention may be implemented. Here, a content provider 150, such as those that commonly supply news, sports, premium channels, etc. generates content and uses it to modulate a carrier frequency for transmission from a satellite transmitter 130 to a satellite 135. The satellite 135 then retransmits the signal to a satellite receiver 145 at the cable operator 155. Alternatively, the link between the content provider 150 and the cable operator 155 via the satellite transmitter 130, the satellite 135, and the satellite receiver 145 may be replaced by a direct, dedicated connection or a network connection such as an ATM backbone or the Internet.

The cable operator 155, after receiving content from the content provider 150, then usually combines that content with other content from various other content providers such as premium service providers, national networks, local stations and others. The cable operator 155 then sends the content to one or more head-ends 165 via a fiber optic network 160. The head-end 165 then distributes the content, normally via copper wire 170, 175, and 180, to one or more consumers 110, 115, and 120.

As mentioned above, all of the types of broadcasts described can be broadcasts of digital data. In each case, a radio frequency (RF) carrier signal is modulated with a digital representation of the content. For example an Motion Pictures Expert Group (MPEG) 2 encoding of a television broadcast can be used to modulate a carrier signal. The modulated carrier is then transmitted over air or wire.

These digital broadcasts generally provide very large bandwidth. Over-the-air ATSC standard digital broadcasts are capable of 19.2 Mbits per second. Cable broadcasts are capable of 30-38 Mbits/channel. Satellite broadcasts operate at speeds of 30 Mbits/transponder. This high bandwidth can allow for a transport data stream to be made up of a bit stream multiplex that carries different information on one multiplex. For example, a digital broadcast can carry an MPEG2 multiplex containing multiple audio, multiple video and multiple data streams instead of one video and one audio track as is typical with an analog broadcast. This ability to multiplex bitstreams into a transport stream allows for virtual channels within one physical channel.

For example, under the adopted ATSC standard for digital TV, the typical 6 MHz channel used for analog TV broadcast supports about 19 Mbps of throughput for terrestrial broadcast. Since audiovisual signals with standard resolution can be compressed using MPEG-2 to sustainable rates of around 6 Mbps, then around 3 or 4 digital TV channels can be safely supported in a single physical channel without congestion. Therefore, a Public Broadcasting System (PBS) virtual channel, for example, may comprise PBS Kids, PBS News, PBS History, etc. Moreover, enough bandwidth remains within the same Transport Stream to provide several additional low-bandwidth non-conventional services such as weather reports, stock indices, headline news, software download such as games or enhanced applications, image-driven classified ads, home shopping, pay-per-view information, and others.

It is therefore practical to anticipate that in the future, the list of services or virtual channels carried in a physical transmission channel of 6 MHz of bandwidth for the U.S. may easily reach ten or more. What is even more important is that the number and type of services may also change continuously, thus becoming a more dynamic medium than what we have today.

It is therefore useful to develop a protocol for describing system information and event descriptions which is followed by organization in charge of a physical transmission channel. System information allows navigation and access to each of the channels within a broadcast transport stream, whereas event descriptions give the user content information for browsing and selection or automatically filtering, personalizing, or caching of content.

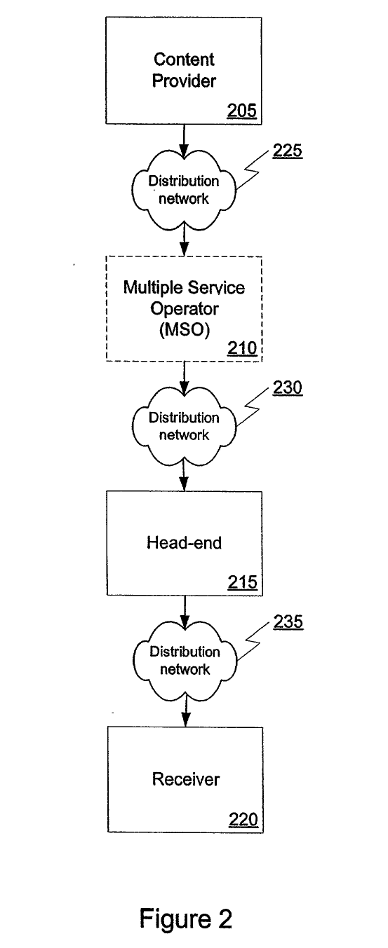

FIG. 2 is a block diagram illustrating a high-level, conceptual view of a network for distributing, consuming, and modifying content based on user preferences according to one embodiment of the present invention. In this example, the system consists of a content provider 205, a broadcasting head-end system 215, and a receiver device 220. The system may also include a Multiple Service Operator (MSO) 210 such as a cable broadcast system as described above with reference to figure ID. This MSO 210 provides an interface between the content provider 205 and the head-end 215. However, the MSO 210 is optional in that the content provider 205 may if fact be an MSO 210 thereby eliminating the distinction.

According to one embodiment of the present invention, content discovery information, such as content descriptors and announcements, may be provided in real-time or pre-show as an in-band transmission. Content descriptors may comprise attribute/value pairs of metadata. For example, if the content to be distributed is a movie, for the given movie the content provider 205 can come up with metadata that is detailed enough to determine whether a given consumer will like the movie based on a user profile, past preferences, etc. This set of metadata may include descriptors such as actors, theme, type of content, studio, year, type of music, etc. According to one embodiment of the present invention, these descriptors may be in the form of Extensible Markup Language (XML) tags. A receiver can later analyze the descriptors and categorize the content accordingly. As will be described below, the receiver can compare this data with a locally stored user profile and determine a degree of correlation. If the correlation is high correlation, the receiver can cache the content for later consumption.

The content data can then be sent 225 from the content provider 205 either to an MSO 210 or directly to a head end 215 via distribution networks 225 and 230. This transmission can be accomplished in at least two ways. One way is to send the data encapsulated in Internet Protocol (IP) packets over the Internet or an ATM backbone network to a router connected to an MSO or head-end. Another method is similar to that described above with reference to figure ID. That is, like traditional cable systems the content provider 205 sends the data to a satellite to be beamed to multiple locations. An MSO 210 or head-end 215 will then receive the content provider's multiplex as a digital bitstream and re-multiplex this bitstream into another multiplex such as an MPEG2 multiplex to be sent to a head-end 210 or consumers via a distribution network 235. The method used depends on the exact application. If there are many points that the content provider will distribute to, satellite is better. If there are only a few points, an ATM backbone is better in terms of cost. In either case, the underlying technology is IP multicast. The content provider creates IP multicast bitstreams to be placed into another multiplex such as an MPEG2 transport.

The MSO 210, if used, receives 225 content from the content provider 205 and sends 230 it to a head-end 215. An MSO 210 can receive input 225 from multiple content providers 205, multiplex the content into a data stream and send the combined content to multiple head-ends 215. The head-end 215 typically receives an input 230 on a fiber optic cable from an MSO 210 or content provider 205 and provides an output 235 on a copper wire for distributing content to one or more consumers.

The receiver 220 is located with the consumer typically in his home. This device 220 could be a personal computer (PC), set top box, personal video recorder (PVR), residential gateway, media server in home, a television with a built in decoder, etc. In other words, it is a content consuming device of some type. The receiver 220 accepts input 235 from the head-end 215, decodes it and then caches or presents it to the consumer for immediate consumption.

As described above, a digital broadcast need not be like an analog broadcast in that it never needs to be consumed in real-time. These broadcast can always be cached and time shifted. According to one embodiment of the present invention, the receiver 220 acts as a filtering and caching device to selectively store content for later consumption. Consequently, only that data which is of interest to the consumer may be cached. As will be described below, the receiver can compare the metadata within the content with a locally stored user profile and determine a degree of correlation. If the correlation is high, the receiver can cache the content for later consumption.

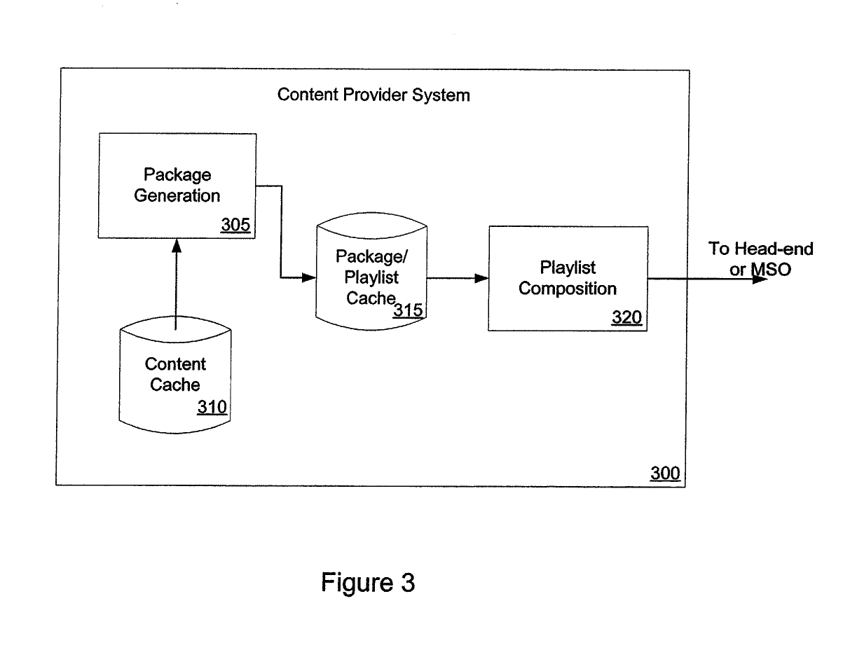

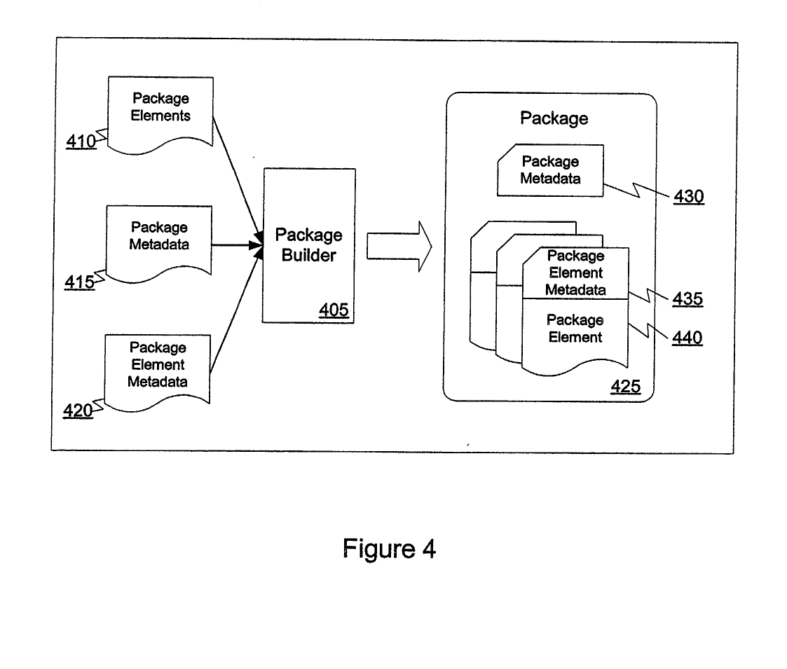

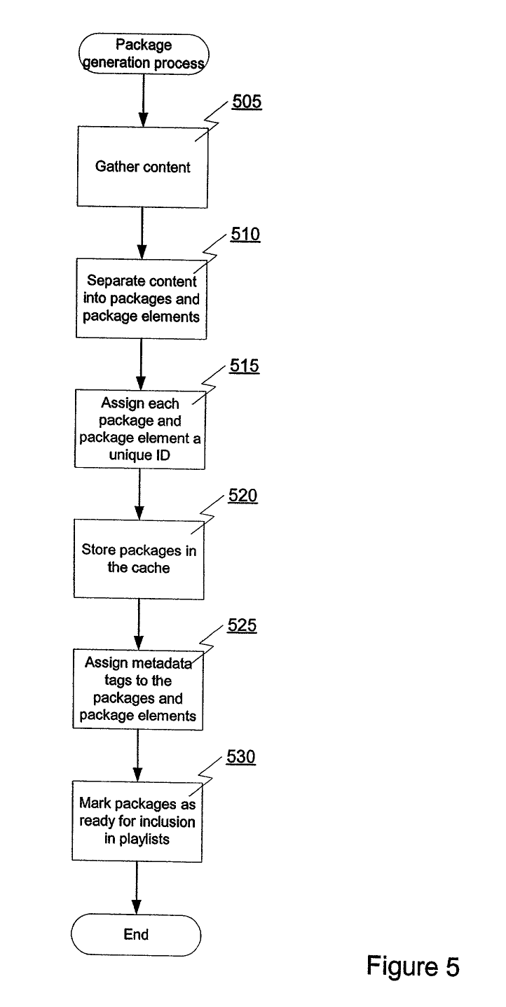

FIG. 3 is a block diagram illustrating a content provider system according to one embodiment of the present invention. In this example, the content provider system 300 consists of a package generation process 305, a content cache 310, a package/playlist cache 315, and a playlist composition process 320. Generally speaking, content is generated, produced, edited and packaged by this system 300. Content to be broadcast is stored in the content cache 310. The package generation process 305 reads the content from the content cache 310 and combines the content data from the content cache 310 with metadata associated with the content to generate packages for broadcast. Details of the package generation process will be discussed below with reference to FIGS. 4 and 5.

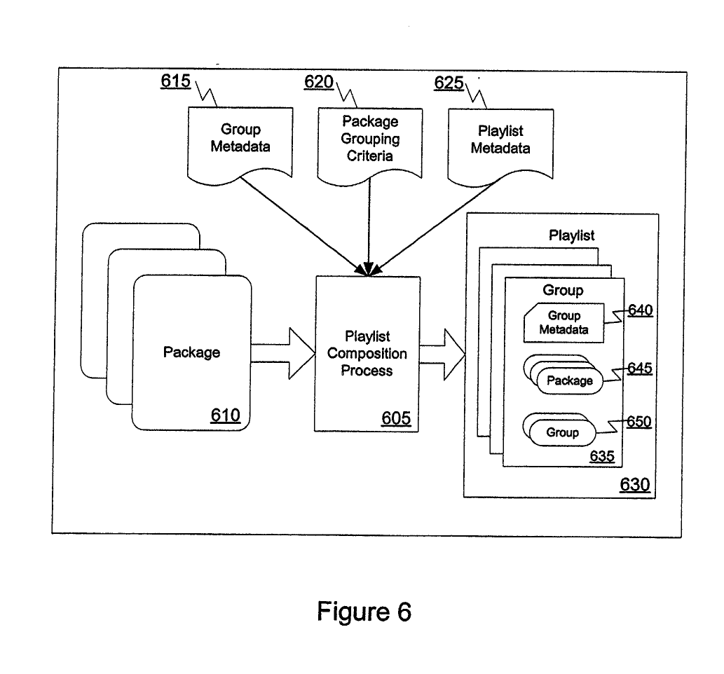

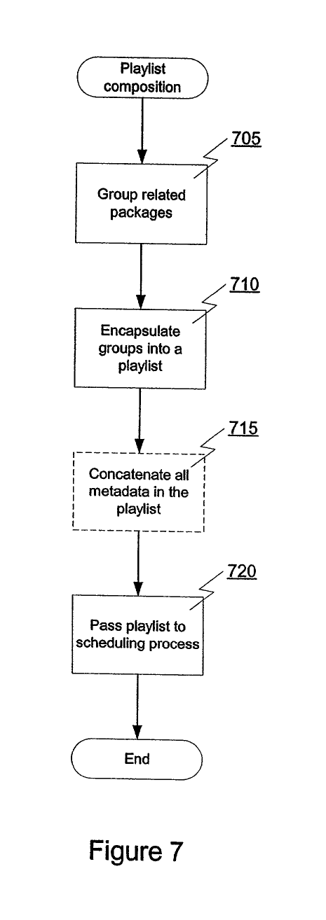

Once the content provider system 300 has a set of packages to be broadcast, these packages are bundled into an ordered set or playlist by the playlist composition process 320. The resulting playlist expresses the content providers interest in playing out the set of packages over a given network in one “data program”. Typically, this is done within one contiguous timeslot within a given broadcast channel. Once the playlists are constructed, they are moved over an appropriate delivery network to the broadcaster's head-end facility. Details of the playlist composition process will be described below with reference to FIGS. 6 and 7.

FIG. 4 is a block diagram illustrating a package generation process according to one embodiment of the present invention. In this example, a package builder application 405 reads content as package elements 410, groups the content into packages 425 and assigns metadata 415 and 420 to the content. The output of this activity is a package 425 or set of packages ready for use within a playlist. The package 425 is made up of package elements 440 representing pieces of content. Package elements 440 may be HTML pages, MP3 files, QuickTime movies, video clips, or content representations that have been stored in the file system. Metadata exists both at the package level as package metadata 430 and at the package element level as package element metadata 440. The package elements 440 representing pieces of content are the fundamental building blocks of the package 425.

The metadata 430 assigned to the package 425 as well as the metadata 435 assigned to the package elements 440 is generated by the content provider system at the time the content is generated and is unchanged in the package generation process. According to one embodiment of the present invention, these attribute/value pairs of metadata can represent a set of descriptors identifying the content of the package and package elements. This metadata should be detailed enough to allow a receiver to determine whether a particular consumer will be interested in a particular piece of content.

For example, if the content to be distributed is a movie, for the given movie the content provider can come up with metadata that is detailed enough to determine whether a given consumer will like the movie based on a user profile, past preferences, etc. This set of metadata may include descriptors such as actors, theme, type of content, studio, year, type of music, etc. As will be described below, the receiver can compare this data with a locally stored user profile and determine a degree of correlation. If the correlation is high, the receiver can cache the content for later consumption.

FIG. 5 is a flowchart illustrating a package generation process according to one embodiment of the present invention. First, at processing block 505, content to be broadcast is gathered from various sources such as a content cache. Associated with each piece of content is a set of metadata describing the content. At processing block 510, the content is separated into packages and package elements. Each package and package element is then assigned a unique identifier at processing block 515. Next, the packages are temporarily stored in a package cache at processing block 520. At processing block 525, the metadata tags associated with the content are assigned to the packages and package elements. Finally, at processing block 530, the packages are marked as ready for inclusion in playlists.

A playlist is an arrangement of related packages, which are to be played out on the network as a unit. Once packages are created, the content provider system may arrange related ones into groups. In turn, groups themselves could belong to other groups. The top-level special purpose group is referred to as a playlist. Like packages, each group may also contain metadata describing the content that it encapsulates. Such an arrangement allows easier content management, as well as smart transmission policy assignment, which will be discussed later.

FIG. 6 is a block diagram illustrating a playlist composition process according to one embodiment of the present invention. This process enables a content provider system to create a playlist 630 as described above. In this example, packages 610 are read by the playlist composition process 605. The playlist composition process 605 also reads package grouping criteria 620 defining groupings of content, group metadata 615 for identifying these groupings, and playlist metadata 625 for identifying the resulting playlist 630. The resulting playlist 630, as described above, is an arrangement of related packages, which are to be played out on the network as a unit. The playlist 630 contains one or more groups 635. The group contains related packages 645 and group metadata 640 identifying the group 635. Optionally, the group 635 may contain other groupings of content 650, each having a similar structure.

Importantly, the playlist composition process does not imply any specific network. Once the playlist is composed, it can be distributed over multiple networks. The network operator is responsible for scheduling and transmitting a playlist over a given network. Additionally, groups that are produced during the playlist composition process may be reused in multiple playlists, which should aid the content provider system in general management of content.

FIG. 7 is a flowchart illustrating a playlist composition process according to one embodiment of the present invention. First, at processing block 705, related packages are grouped together based on package grouping criteria and the metadata within the individual packages. These groups are then encapsulated into a playlist including metadata identifying the group at processing block 710. As stated above, the groups created during the process are persistent and may be re-used in other playlists. Optionally, at processing block 715 all metadata in the playlist may be concatenated to form a new set of metadata. Finally, the resulting playlists are passed on to a scheduling process.

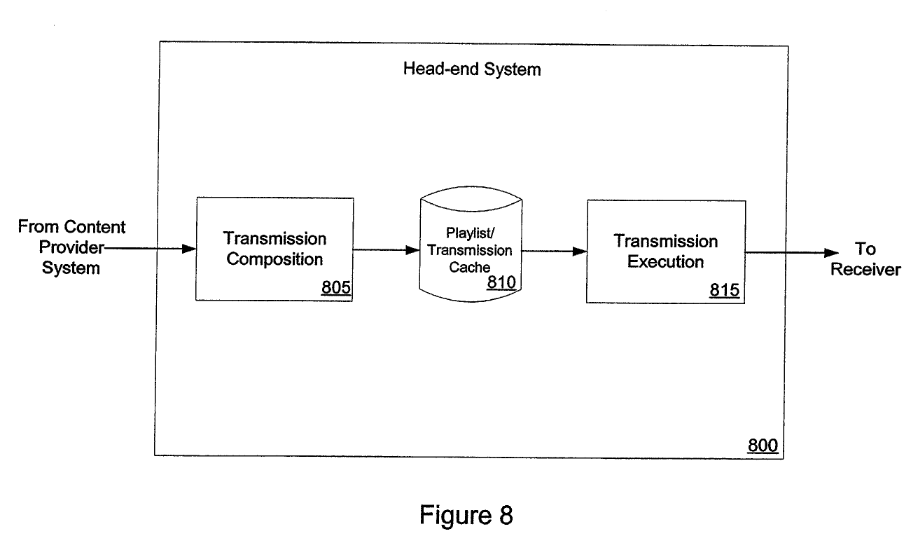

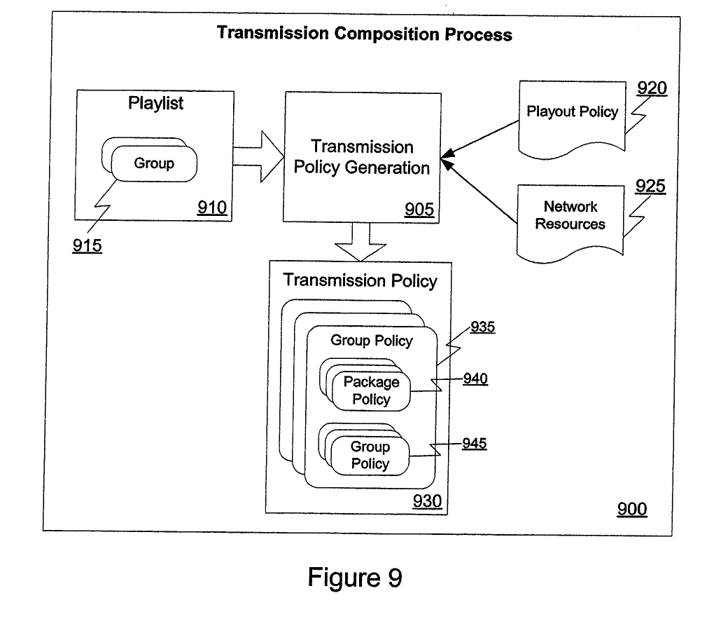

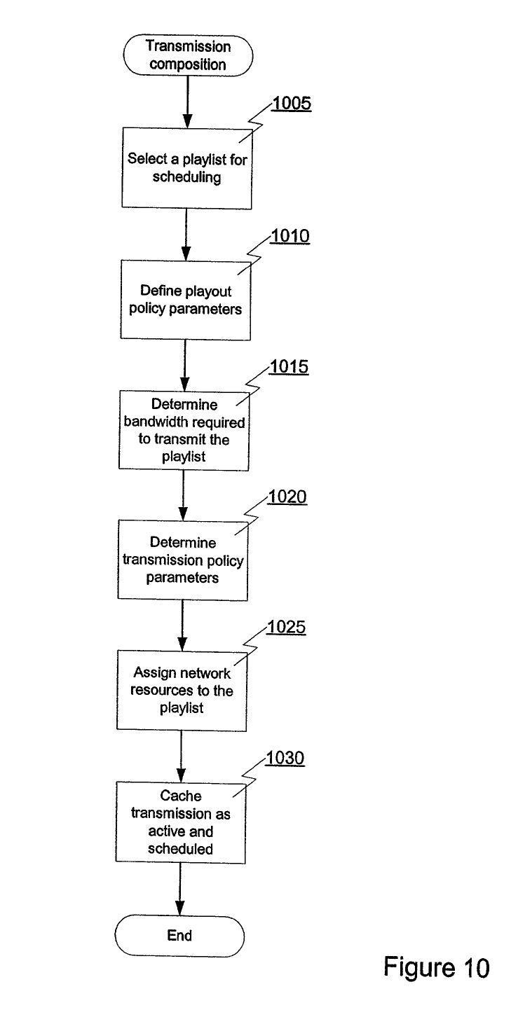

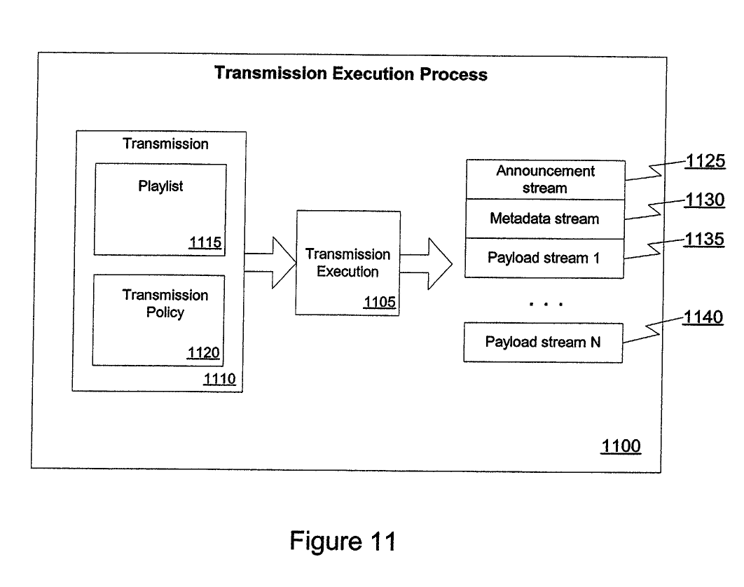

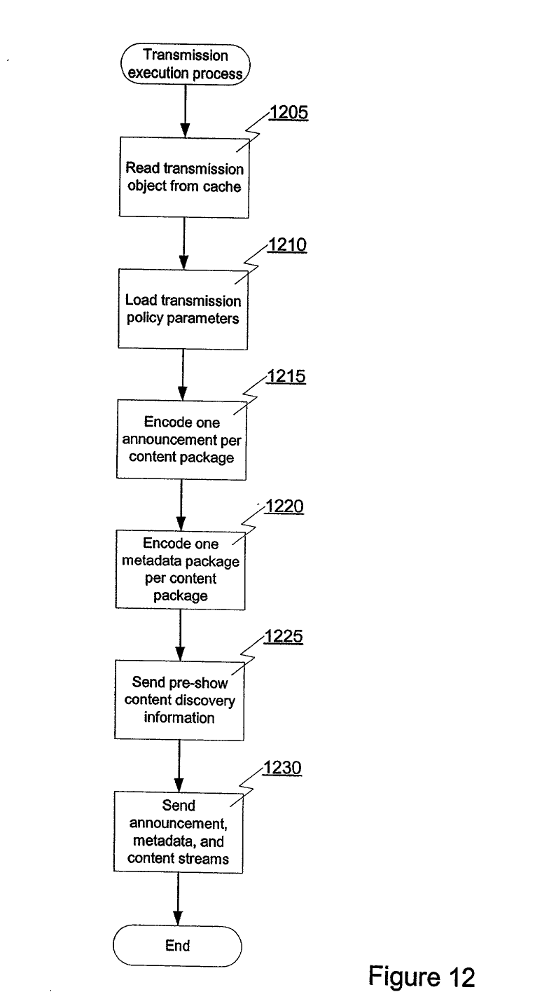

FIG. 8 is block diagram illustrating a head-end system 800 according to one embodiment of the present invention. In this example, the head-end system 800 consists of a transmission composition process 805, a playlist/transmission cache 810, and a transmission execution process 815. Assuming a store and forward model of content distribution, the playlists and packages are sent from a content provider's system to a bandwidth owner's head-end facility to be transmitted to consumers at a later, scheduled time. Once received by the head-end system 800, the transmissions are composed and scheduled by the transmission composition process 805. Details of this process will be discussed below with reference to FIGS. 9 and 10. The composed transmissions are temporarily stored in the playlist/transmission cache 810 until their scheduled broadcast time. The transmission execution process 815 will then play out a scheduled transmission at the appropriate broadcast time. Details of the transmission execution process will be discussed below with reference to FIGS. 11 and 12.

FIG. 9 is block diagram illustrating a transmission composition process 900 according to one embodiment of the present invention. In this example, a transmission policy generation process 905 reads a playlist 910, playout policies 920, and details of available network resources 925 and generates a transmission policy 930. In short, transmission policy is a description of how a playlist is to be played out by a transmission execution process. That is, the policy is a set of properties describing how the content should be transmitted over the delivery network to the consumers. A playlist 910 together with its transmission policy 930 is defined as a transmission. Transmissions contain knowledge regarding how, when, and what to play out.

Structurally, the transmission policy 930 is a tree mimicking the playlist tree, but containing a set of policy settings in each node. A transmission policy 930 may contain one or more group policies 935 each containing one or more package policies 940 and one or more group policies 945. The policy settings defined in a node of the tree are applied to each of its descendents. A descendent may overwrite any of the settings it ‘inherits’ from its parent, or introduce a new one. This mechanism allows for various levels of granularity of policy from per-playlist to per-package.

A transmission policy 930 may be based on playout policy 920 and network resources 925 available for the transmission. Playout policy 920 is a list of protocol-neutral, and protocol specific transmission settings. The former may include the number of retransmissions, the content order, etc. The latter includes settings specific to the protocol used by the transmission execution process.

As a part of transmission policy generation, the process reserves network resources for broadcast of a playlist, thereby scheduling the playlist. The outputs of this process are therefore transmissions. Unlike a playlist, which is transport independent and is focused on content, the transmission is focused on broadcasting this content over a given digital broadcast network. The transmission combines the playlist with network-specific parameters, such as IP multicast addresses, announcement and metadata encoding schemes, bandwidth usage for announcement, metadata and payload, etc.

FIG. 10 is a flowchart illustrating a transmission composition process according to one embodiment of the present invention. Initially, at processing block 1005 a playlist is selected for scheduling. Next, at processing block 1010, playout policy parameters are defined for the playlist. As defined above, the playout policy is a list of protocol-neutral, and protocol specific transmission settings including information such as the number of retransmissions, the content order, etc. as well as protocol-specific settings.

Once the playout policy is in place, the amount of bandwidth that is needed to transmit the playlist is determined at processing block 1015. Next, at processing block 1020, the transmission policy parameters with regard to use of the bandwidth for announcement, metadata and payload are determined and defined. Network resources such as IP multicast addresses, timeslot and bandwidth are assigned to the playlist at processing block 1025. Finally, at processing block 1030, the transmission is cached and flagged as active and scheduled.

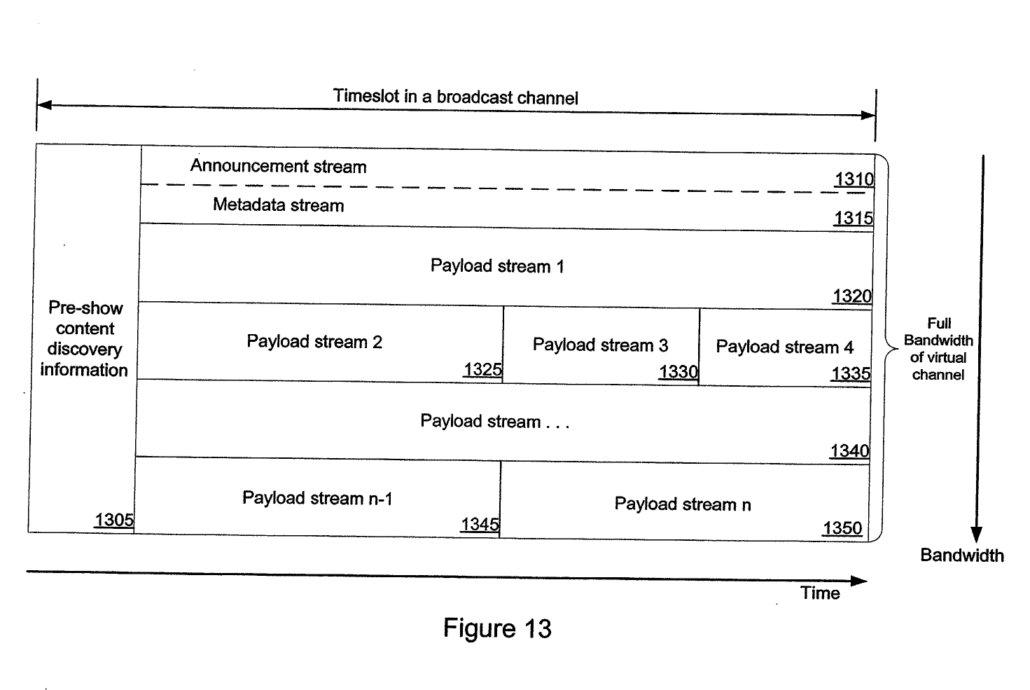

FIG. 11 is a block diagram illustrating a transmission execution process 1100 according to one embodiment of the present invention. The transmissions execution process 1100 performs the broadcast of packaged content to consumers. A transmission 1110, as generated by the transmission composition process described above, contains all of the information necessary for the transmission execution process to play out packages. As already discussed, the transmission 1110 includes a playlist 1115 and transmission policies 1120. Generally speaking, the transmission execution process 1100 reads the playlist 1115 and generates a number of transmission data streams in accordance with the transmission policy 1120. According to one embodiment of the present invention, the transmission data streams can include an announcement data stream 1125, a metadata stream 1130, and a number of payload data streams 1135-1140. The details of these data streams will be discussed below with reference to FIGS. 13-15.

The transmission objects, according to one embodiment of the present invention, may already be located in a cache at the head end facility. All information relating to the transmission such as playlists, transmission policies, contents of the playlists and content discovery information is also available at this facility. At a scheduled time, the transmission execution process is woken up by a scheduler or some such program in the head-end system. This is a wake-up call which is typically a few minutes before the actual broadcast time.

FIG. 12 is a flowchart illustrating a transmission execution process according to one embodiment of the present invention. Initially, at processing block 1205, the appropriate transmission object is read from the cache. Next, at processing block 1210, the transmission policy parameters for use with this transmission are loaded. One announcement and one metadata package are encoded for each content package at processing blocks 1215 and 1220. Pre-show content discovery information is sent before the start of the group data program or show at processing block 1225. Finally, at processing block 1230, the encoded announcement, metadata, and content streams are broadcast via the network to the consumers.

FIG. 13 is a block diagram illustrating a transmission format according to one embodiment of the present invention. Here, the entire transport stream for a given timeslot in a broadcast is illustrated. Initially, pre-show content discovery information 1305 may be broadcast. This information may include announcement data and metadata for all content that will be broadcast during the timeslot for a particular time period. According to one embodiment of the present invention, the pre-show content discovery information 1305 is sent at the fall bandwidth of the channel to minimize the amount of time required to send this information. This pre-show content discovery information 1305 provides any receiver attached to the network and operating at the time of its broadcast with information sufficient to determine which content to be broadcast during the timeslot may be of interest to a particular consumer. The receiver, as will be described below, can then make a determination of which content to cache or present to the consumer.

After the pre-show content discovery information 1305 has been sent, the announcement data stream 1310, the metadata stream 1315, and a number of payload data streams 1320-1350 are sent. Payload data stream 1 1320 through payload data stream n 1350 represent various content data. As can be seen from the relative sizes of the various payload streams 1320-1350, the content can be of varying size and duration during the timeslot. In this example, the bandwidth allocated to the various payload streams 1320-1350 remains constant throughout the timeslot.

In this example, both the announcement data stream 1310 and metadata stream 1315 are sent concurrently with the payload data streams 1320-1350 as in-band, real-time information. “In-band” refers to the fact that this information is available within the same physical frequency as the data program. “Real-time” indicates that the information is available during the data program. This data describes the payload data streams as did the pre-show content discovery information 1305 and allows a receiver that tunes in to the data program after the pre-show content discovery information broadcast has been completed to identify content within the payload data streams so that the receiver can make a determination of which content to cache or present to the consumer. The announcement data stream 1310 is a reduced version of the pre-show content discovery data 1305. That is, the announcement data stream 1310 provides a description of a schedule of content to be broadcast during a transmission. According to one embodiment of the present invention, the announcement date stream 1310 is implemented with Session Announcement Protocol (SAP)/Session Description Protocol (SDP).

The metadata stream 1315 is the descriptive metadata for the various payload data streams. Both the announcement data stream 1310 and the metadata stream 1315 may be sent in a reduced amount of bandwidth in relation to the payload data streams 1320-1350 and the data within the announcement data stream 1310 and the metadata stream 1315 may be carouselled throughout the timeslot of the broadcast. In this manner, content discovery information is trickle streamed during the show or data program thereby allowing new users that tune in during the program to receive rich information about the program.

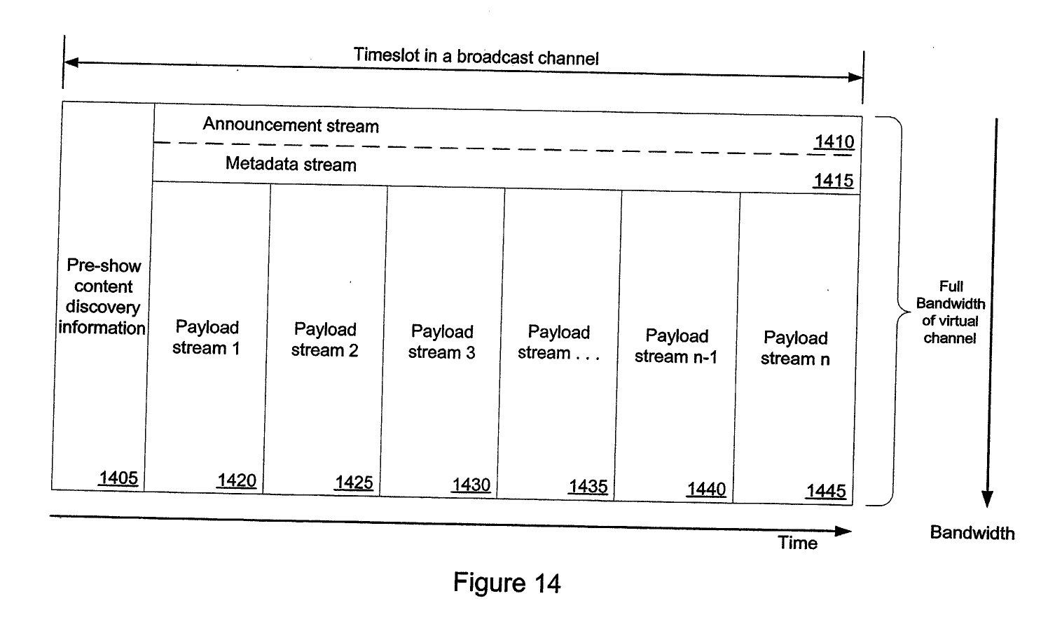

FIG. 14 is a block diagram illustrating a transmission format according to an alternative embodiment of the present invention. As with the previous example, pre-show content discovery information 1405 is sent using the full bandwidth of the channel at the beginning of the broadcast. After the pre-show content discovery information 1405 has finished, an announcement data stream 1410 and a metadata stream 1415 are sent as in the previous example. However, in this example, the payload data streams 1420-1445 are sent in series rather than in parallel as was the case in the previous example. That is, payload data stream 1 1420 is sent using all bandwidth that is not used by the announcement data stream 1410 and the metadata stream 1415. Then, payload data stream 2 1425 through payload data stream n 1445 are sent in a similar manner. This method may be particularly useful in a content distribution network where receivers cache content prior to providing it to a consumer rather than providing content in real-time.

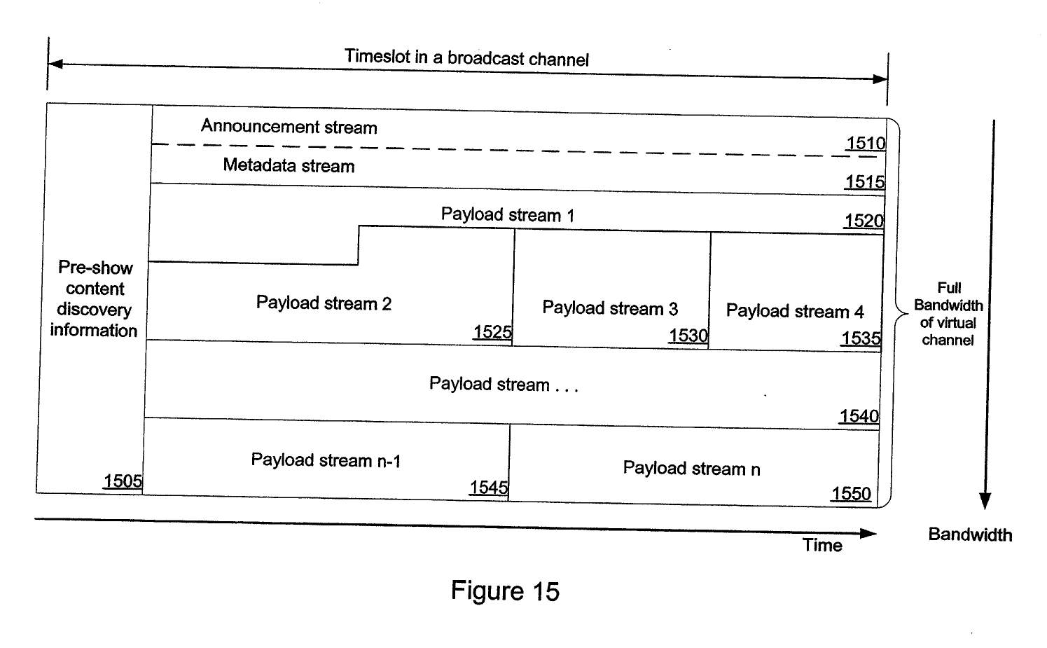

FIG. 15 is a block diagram illustrating a transmission format according to an alternative embodiment of the present invention. In this example, the pre-show content discovery information 1505, announcement data stream 1510, and the metadata stream 1515 are sent as described in the previous two examples. Payload data stream 1 1520 through n 1550 are sent in parallel as described in the example illustrated by FIG. 13. However, the bandwidth allotted to payload data stream 1 1520 does not remain constant. The bandwidth of this stream is reduced after some amount of time or the occurrence of some event. The bandwidth made available is then allotted to other payload data streams 1525-1535.

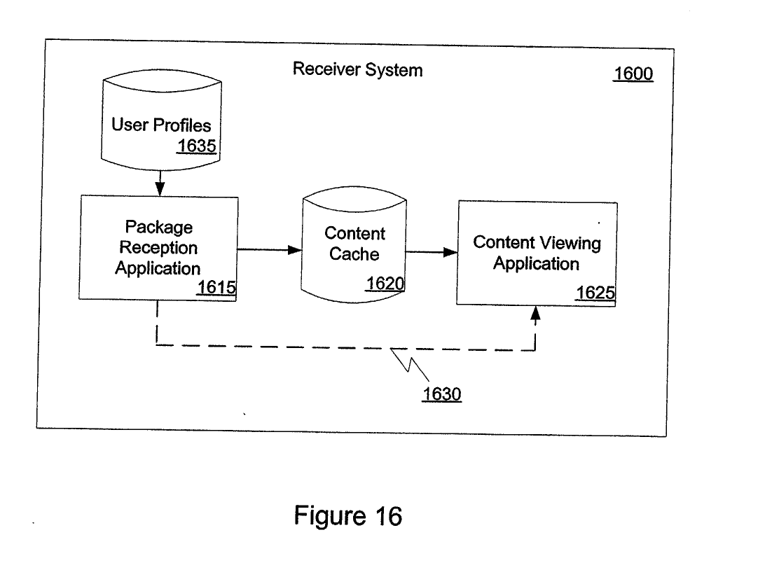

FIG. 16 is a block diagram illustrating a receiver system 1600 according to one embodiment of the present invention. A package reception application 1615 receives data streams broadcast via the network and filters the content based on user preferences generated within the system. For example, a particular consumer may wish to view content related to sports but not classic movies. The receiver will therefore filter out the classic movies content but receive sports content. The filtered content can then be cached in a content cache 1620. At some later time, at the consumer's convenience, a content viewing application 1625 can present content stored in the cache 1620 to the consumer. Alternatively, the package reception application can provide filtered content directly 1630 to the content viewing application 1625 for immediate use by the consumer. Additionally, content discovery information may be in-band, real-time; in-band, pre-show; or out-of-band, pre-show. For example, out-of-band, pre-show information may be transmitted to a receiver via a back-channel or through email.

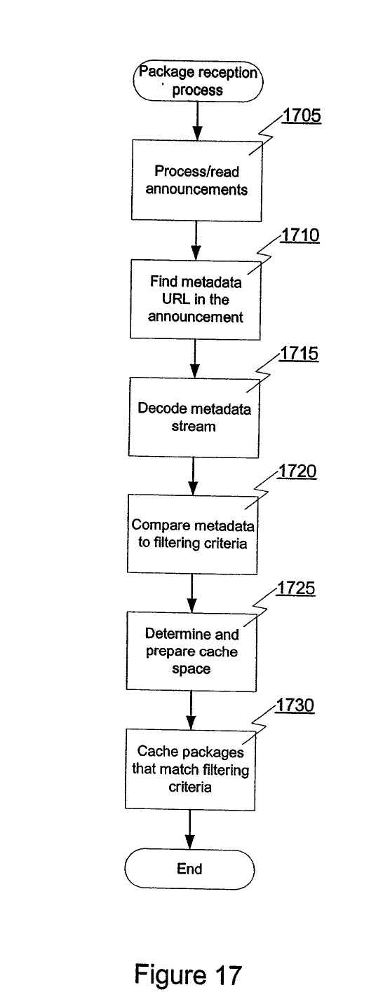

FIG. 17 is a flowchart illustrating a package reception process according to one embodiment of the present invention. Initially, at processing block 1705, announcement data is read. This can be in the form of reading pre-show content discovery information or reading real-time content discovery information, such as the announcement data stream, depending on when the receiver becomes active relative to the broadcast. In either event, the receiver begins reading announcement data at a known IP address. Next, at processing block 1710, the receiver finds the location of the metadata stream, e.g., the Uniform Resource Locator (URL), of the metadata stream from within the announcement data. The receiver can then find and decode the metadata stream at processing block 1715. Then, at processing block 1720, the receiver compares the metadata to filtering criteria. As mentioned above, the receiver compares the metadata within the content with a locally stored user profile and determines a degree of correlation. If the correlation is high, the receiver can cache the content for later consumption. For example, if a particular consumer likes sports, the receiver will have stored user preference data indicating this preference. Metadata indicating a broadcast of sports content will therefore show a match. More detailed user preference data may further indicate which sports and which teams. If a high correlation is found, the consumer may be interested in the content so the receiver may cache that content or present it for immediate use.

After the metadata has been compared and content has been found that may be of interest to the consumer, the receiver can determine how much cache space is needed to store the content and can prepare that space at processing block 1725. Finally, at processing block 1730, the receiver can cache packages with metadata that matches the filtering criteria. Alternatively, the receiver may present the content to the consumer for immediate use rather than caching the content for future use.

What is claimed is:

1. A method comprising:
generating packets of content data to be broadcast from a content provider system via a network wherein the packets of content data include metadata describing the content data;
composing a playlist designating an order in which said packets of content are to be broadcast;
composing a transmission of said packets of content data based on said playlist;
executing said transmission of said packets of content data according to said playlist;
receiving said packets of content data at a receiver connected with said content provider system via said network; and
selectively caching or presenting the packets based on a comparison of the metadata describing the content data and user profile information stored on the receiver.

2. The method of claim 1, wherein said generating packets of content data and said composing a playlist are performed by the content provider system.

3. The method of claim 1, wherein said composing a transmission and executing said transmission are performed by a broadcast system head-end.

4. The method of claim 1, wherein said metadata comprises Extensible Markup Language (XML) tags.

5. The method of claim 1, wherein said metadata comprises pre-show content discovery information.

6. The method of claim 1, wherein said metadata comprises real-time content discovery information.

7. The method of claim 1, wherein said generating packets of content data comprises:
gathering content to be broadcast from a content cache on the content provider system;
separating said content into packages and package elements within the packages;
assigning each package and package element a unique identifier;
storing said packages in a package cache;
assigning metadata tags identifying content within the packages and package elements to the packages and package elements; and
marking tagged packages as ready for inclusion in playlists.

8. The method of claim 7, wherein said composing a playlist comprises:
grouping all related packages into content groups;
encapsulating content groups into a playlist; and
passing the playlist to a transmission composition process.

9. The method of claim 8, further comprising concatenating two or more portions of metadata in the playlist prior to passing the playlist to a transmission composition process to generate metadata representing the entire playlist.

10. The method of claim 8, wherein said encapsulating content groups into a playlist further comprises encapsulating said content groups into a Motion Picture Experts Group-2 (MPEG-2) multiplex.

11. The method of claim 1, wherein said composing a transmission comprises:
selecting a playlist for scheduling;
defining playout policy parameters;
determining bandwidth required to transmit the playlist;
determining transmission policy parameters based on the bandwidth required to transmit the playlist and the playout policy parameters;
assigning network resources to the playlist based on the transmission policy;
caching the transmission as active and scheduled.

12. The method of claim 8, wherein said executing said transmission comprises:
reading a previously generated transmission;
loading transmission policy parameters;
encoding announcement data for each content package into an announcement data stream describing a schedule of content to be broadcast during execution of the transmission;
encoding metadata for each content package into a metadata stream providing a description of content within a content stream;
sending pre-show content discovery information describing a schedule of content to be broadcast during execution of the transmission; and
sending announcement, metadata and content data streams according to a predefined timeslot format.

13. The method of claim 12, wherein said receiving said packets of content data comprises:
reading the announcement data stream;
finding a predetermined metadata Uniform Resource Locator (URL) in the announcement data stream identifying a location of the metadata stream;
decoding the metadata stream identified by the predetermined metadata URL;
correlating metadata from the decoded metadata stream to user profile information stored within the receiver;
preparing cache space adequate to store content that has metadata matching the user profile information; and
caching packages with metadata highly correlated with the filtering criteria.

14. A system comprising:
a content provider system to generate packets of content data to be broadcast from the content provider system via a first network connected with the content provider system wherein the packets of content data include metadata describing the content data and compose a playlist designating an order in which said packets of content are to be broadcast;
a broadcast system head-end connected with said content provider system via said first network to receive said packets of content data and said playlist, compose a transmission of said packets of content data based on said playlist, and execute said transmission of said packets of content data according to said playlist; and
a receiver connected with said broadcast system head-end via a second network to receive said packets of content data and selectively cache or present the packets based on a comparison of the metadata describing the content data and user profile information stored on the receiver.

15. The system of claim of claim 14, wherein said content provider system:
gathers content to be broadcast from a content cache on the content provider system;
separates said content into packages and package elements within the packages;
assigns each package and package element a unique identifier;
stores said packages in a package cache;
assigns metadata tags identifying content within the packages and package elements to the packages and package elements; and
marks tagged packages as ready for inclusion in playlists.

16. The system of claim 15, wherein said content provider system:
groups all related packages into content groups;
encapsulates content groups into a playlist; and
passes the playlist to a transmission composition process.

17. The system of claim 16, content provider system further concatenates two or more portions of metadata in the playlist prior to passing the playlist to a transmission composition process to generate metadata representing the entire playlist.

18. The system of claim 14, wherein said broadcast system head-end:
selects a playlist for scheduling;
defines playout policy parameters;
determines bandwidth required to transmit the playlist;
determines transmission policy parameters based on the bandwidth required to transmit the playlist and the playout policy parameters;
assigns network resources to the playlist based on the transmission policy;
caching the transmission as active and scheduled.

19. The system of claim 15, wherein said broadcast system head-end:
reads a previously generated transmission;
loads transmission policy parameters;
encodes announcement data for each content package into an announcement data stream describing a schedule of content to be broadcast during execution of the transmission;
encodes metadata for each content package into a metadata stream providing a description of content within a content stream;
sends pre-show content discovery information describing a schedule of content to be broadcast during execution of the transmission; and
sends announcement, metadata and content data streams according to a predefined timeslot format.

20. The system of claim 19, wherein said receiver:
reads the announcement data stream;
finds a predetermined metadata Uniform Resource Locator (URL) in the announcement data stream identifying a location of the metadata stream;
decodes the metadata stream identified by the predetermined metadata URL;
correlates metadata from the decoded metadata stream to user profile information stored within the receiver;
prepares cache space adequate to store content that has metadata matching the user profile information; and
caches packages with metadata highly correlated with the filtering criteria.

21. A machine-readable medium having stored thereon data representing sequences of instructions, the sequences of instructions which, when executed by a processor, cause the processor to:
generate packets of content data to be broadcast from a content provider system via a network wherein the packets of content data include metadata describing the content data;
compose a playlist designating an order in which said packets of content are to be broadcast;
compose a transmission of said packets of content data based on said playlist;
execute said transmission of said packets of content data according to said playlist;
receive said packets of content data at a receiver connected with said content provider system via said network; and
selectively cache or present the packets based on a comparison of the metadata describing the content data and user profile information stored on the receiver.

22. The machine-readable medium of claim 21, wherein said generating packets of content data and said composing a playlist are performed by the content provider system.

23. The machine-readable medium of claim 21, wherein said composing a transmission and executing said transmission are performed by a broadcast system head-end.

24. The machine-readable medium of claim 21, wherein said metadata comprises Extensible Markup Language (XML) tags.

25. The machine-readable medium of claim 21, wherein said metadata comprises pre-show content discovery information.

26. The machine-readable medium of claim 21, wherein said metadata comprises real-time content discovery information.

27. The machine-readable medium of claim 21, wherein said generating packets of content data comprises:
gathering content to be broadcast from a content cache on the content provider system;
separating said content into packages and package elements within the packages;
assigning each package and package element a unique identifier;
storing said packages in a package cache;
assigning metadata tags identifying content within the packages and package elements to the packages and package elements; and
marking tagged packages as ready for inclusion in playlists.

28. The machine-readable medium of claim 27, wherein said composing a playlist comprises:
grouping all related packages into content groups;
encapsulating content groups into a playlist; and
passing the playlist to a transmission composition process.

29. The machine-readable medium of claim 28, further comprising concatenating two or more portions of metadata in the playlist prior to passing the playlist to a transmission composition process to generate metadata representing the entire playlist.

30. The machine-readable medium of claim 21, wherein said composing a transmission comprises:
selecting a playlist for scheduling;
defining playout policy parameters;
determining bandwidth required to transmit the playlist;
determining transmission policy parameters based on the bandwidth required to transmit the playlist and the playout policy parameters;
assigning network resources to the playlist based on the transmission policy;
caching the transmission as active and scheduled.

31. The machine-readable medium of claim 28, wherein said executing said transmission comprises:
reading a previously generated transmission;
loading transmission policy parameters;
encoding announcement data for each content package into an announcement data stream describing a schedule of content to be broadcast during execution of the transmission;
encoding metadata for each content package into a metadata stream providing a description of content within a content stream;
sending pre-show content discovery information describing a schedule of content to be broadcast during execution of the transmission; and
sending announcement, metadata and content data streams according to a predefined timeslot format.

32. The machine-readable medium of claim 31, wherein said receiving said packets of content data comprises:
reading the announcement data stream;
finding a predetermined metadata Uniform Resource Locator (URL) in the announcement data stream identifying a location of the metadata stream;
decoding a metadata stream identified by the predetermined metadata URL;
correlating metadata from the decoded metadata stream to user profile information stored within the receiver;
preparing cache space adequate to store content that has metadata matching the user profile information; and
caching packages with metadata highly correlated with the filtering criteria.
